(19) United States
(12) Patent Application Publication
(10) Pub. No.: US 2025/0270396 A1
(43) Pub. Date: Aug. 28, 2025

(54) Polyolefin Composition Comprising Heterophasic Polypropylene Polymers and Recycled Plastic Materials

(71) Applicant: Borealis AG, Vienna (AT)

(72) Inventors: Yi Liu, Linz (AT); Franz Ruemer, Linz (AT); Paul Johann Freud, Linz (AT); Jörg Fischer, Linz (AT); Reinhold W. Lang, Linz (AT)

(21) Appl. No.: 18/857,848

(22) PCT Filed: Apr. 18, 2023
(86) PCT No.: PCT/EP2023/059947

§ 371 Date: Oct. 18, 2024

(30) Foreign Application Priority Data
Apr. 19, 2022 (EP) 22168810.4

(51) Int. Cl. C08L 23/14; C08K 5/00

(52) U.S. Cl. CPC C08L 23/142; C08K 5/005; C08L 2201/08; C08L 2203/18; C08L 2205/025; C08L 2207/02; C08L 2207/20

(57) ABSTRACT

A polyolefin composition is provided including 60-95 wt % (based on the overall weight of the polyolefin composition) of at least one heterophasic propylene copolymer (HECO) with a total ethylene (C2) content (as determined according to CRYSTEX QC analysis) of 0.5 to 4.5 wt.-%, and a xylene cold soluble fraction (determined at 25° C. according to ISO 16152) of 2-9 wt % and a melt flow rate MFR₂ (ISO 1133, 2.16 kg, 230° C., measured according to ISO 1133) of 0.1 to 1 g/10, 5-40 wt % (based on the overall weight of the polyolefin composition) of a mixed-plastics polypropylene blend of recycled material having an ethylene (C2) content determined according to CRYSTEX QC analysis of 5 to 35 wt %, and optionally further additives, wherein the sum of all ingredients always adds up to 100 wt %.

### CROSS-REFERENCE TO RELATED APPLICATIONS

This application is the United States national phase of International Patent Application No. PCT/EP2023/059947 filed on Apr. 18, 2023, and claims priority to European Patent Application No. 22168810.4 filed Apr. 19, 2022, the disclosures of each of which are hereby incorporated by reference in their entireties.

### BACKGROUND

### Technical Field

The present disclosure relates to a polyolefin composition comprising at least one heterophasic polypropylene copolymer, and recycled plastic material, to an article comprising the polyolefin composition and a process for preparing such polyolefin composition.

### Technical Considerations

Polyolefins, in particular polyethylene and polypropylene, are increasingly consumed in large amounts in a wide range of applications, including packaging for food and other goods, fibres, automotive components, and a great variety of manufactured articles. Polyethylene based materials are a particular problem as these materials are extensively used in packaging. Taking into account the huge amount of waste collected compared to the amount of waste recycled back into the stream, there is still a great potential for intelligent reuse of plastic waste streams and for mechanical recycling of plastic wastes.

With their inherent versatility, plastics play crucial roles in a sustainable and resource-efficient economy. However, as more and more plastic has been created and used in a mode of linear economy, plastic waste is nowadays considered a serious social problem. For that, it is important to form a circular economy that brings plastic waste back to a second life, i.e., to recycle it. This not only avoids leaving plastic waste in the environment but also recovers its value.

The European Commission confirmed in 2017 that it would focus on plastics production and use. The EU goals are that 1) by 2025 at least 55% of all plastics packaging in the EU should be recycled and 2) by 2030 all plastic packaging placed in the EU market is reusable or easily recycled. This pushes the brand owners and plastic converters to pursue disclosures with recyclates or virgin/recyclate blends. More recently, in 2021, EU agreed to a tax on plastic packaging waste. The tax, introduced as of 1 Jan. 2021, is calculated on the weight of non-recycled plastic packaging waste “with a call rate of €0.80/kilogram with a mechanism to avoid excessively regressive impact on national contributions.”

It is therefore urgently needed to find ways of recycling plastic waste. However, recycled plastics are normally inferior to virgin plastics in their quality due to degradation, contamination and/or mixing of different plastics.

One major trend in the field of polyolefins is the use of recycled materials, which are derived from a wide variety of sources. Durable goods streams such as those derived from yellow bags, yellow bins, community collections, waste electrical equipment (WEE) and/or end-of-life vehicles (ELV) contain a wide variety of plastics. These materials can be processed to recover acrylonitrile-butadiene-styrene (ABS), high impact polystyrene (HIPS), polypropylene (PP) and/or polyethylene (PE) plastics. Separation can be carried out using density separation in water and then further separation based on fluorescence, near infrared absorption or raman fluorescence. However, it is commonly quite difficult to obtain either pure recycled polypropylene or pure recycled polyethylene.

Generally, recycled quantities of polypropylene on the market are mixtures of both polypropylene (PP) and polyethylene (PE), this is especially true for post-consumer waste streams. Moreover, commercial recyclates from post-consumer waste sources are conventionally cross-contaminated with non-polyolefin materials such as polyethylene terephthalate, polyamide, polystyrene and/or non-polymeric substances like wood, paper, glass and/or aluminum. These cross-contaminations drastically limit final applications of recycling streams such that no profitable final uses remain. Polyolefinic recycling materials, especially from post-consumer waste streams, are a mixture of PE and PP. The better the quality of the recyclate is, the less available it is and the more expensive it is.

The quality issue in recyclates compared to the virgin ones can be to some extent overcome by mixing the recyclates with virgin polymers. Compositions comprising virgin polymers (i.e., polymers used for the first time) and recycled mixed plastics have been studied.

EP 3 715 410 A1 discloses a composition comprising a recycled polymer composition (RPC) and a heterophasic propylene copolymer (HECO). The recycled polymer composition (RPC) comprises at least 80 wt.-%, of a recycled polypropylene. The heterophasic propylene copolymer (HECO) has a xylene cold soluble (XCS) fraction the range of 5.0 to 18 wt. %, and a melt flow rate MFR2 (230° C./2.16 kg) in the range of 0.05 to 1.5 g/10 min.

WO 2021/032459 A1 discloses polypropylene-polyethylene blends comprising a component A) being a recyclate blend with total C2 content of 12-14.5 wt % and a component B) being a virgin random polypropylene copolymer a total C2 content of 3.7 wt % and a XCS content of 6.5 wt %.

WO 2021/032460 A1 discloses polypropylene-polyethylene blends comprising a component A) being a recyclate blend and a component B) being a virgin random polypropylene homopolymer.

Wang et al. (Mechanical and Processing Enhancement of a Recycled HDPE/PPR-Based Double-Wall Corrugated Pipe via a POE-g-MAH/CaCO3/HDPE Polymer Composite; ACS Omega, 2021, 6(30), 19705-19716) use a modified maleic anhydride-grafted polyethylene (POE-g-MAH) compatibilizer to increase the interfacial adhesion and dispersion. With the surface modification of calcium carbonate, a POE-g-MAH/CaCO3/HDPE polymer composite has been prepared. Such modified polymer composites can further reinforce the processing performance and mechanical properties of recycled HDPE and PPR (random copolymer polypropylene) materials. The results indicated that, with the introduction of the polymer composite, significant enhancement of the recycled materials in the aspects of processability, tensile strength, flexural performance, and impact force could be obtained, and the POE-g-MAH/CaCO3/HDPE polymer composite would contribute to the impressive balance between high rigidity and toughness. In addition, the feasibility and mechanical properties of the recycled HDPE-PPR-POE-g-MAH/CaCO3/HDPE blended system were also studied: with the help of a composite microcapsule, the gap of mechanical capacity between recycled and non-recycled materials was further reduced, and such a blended system was capable of being commercialized in the piping industry.

Matias et al. (Use of recycled polypropylene/poly(ethylene terephthalate) blends to manufacture water pipes: An industrial scale study, Waste Management (Oxford, United Kingdom); 2020, 101, 250-258) explore the possibility of incorporating either PP or PET originated from plastic solid waste (PSW) in pipe manufacturing, with competitive mechanical properties compared to those prepared from virgin materials. To achieve this industrial disclosure, a process was developed using PP/PET 70/30 wt % formulations and the impact of replacing the virgin material by the different PSW in the microstructure, thermal and mechanical properties of the final material was analyzed. The impact of using a compatibilizer able to counteract the natural immiscibility between the PP and PET domains was also assessed. The developed formulation with recycled PET is a good example of the applicability of work developed at a laboratory scale into industrial-scale production.

As one can see, the use of recycled polypropylene for replacing virgin polypropylene is in general possible. However, there is still a need for improving or maintaining thermomechanical properties such as fatigue crack growth performance when replacing virgin polymer by recycled material.

### SUMMARY

Thus, it was an object underlying the proposed disclosure to provide a polyolefin composition wherein at least a part of virgin polyolefin is replaced by polyolefin material recovered from waste plastic material while thermomechanical properties of such a polyolefin composition are at least maintained or even improved.

This object has been solved by providing a polyolefin composition comprising:
a) 60-95 wt % (based on the overall weight of the polyolefin composition) of at least one heterophasic propylene copolymer (HECO) with a total ethylene (C2) content (as determined according to CRYSTEX QC analysis) of 0.5 to 4.5 wt.-%, and a xylene cold soluble fraction (determined at 25° C. according to ISO 16152) of 2 to 9 wt % and a melt flow rate MFR₂ (ISO 1133, 2.16 kg, 230° C., measured according to ISO 1133) of 0.1 to 1 g/10 min,
b) 5-40 wt % (based on the overall weight of the polyolefin composition) of a mixed-plastics polypropylene blend of recycled material having an ethylene (C2) content (as determined according to CRYSTEX QC analysis) of 5 to 35 wt %, and
c) optionally further additives, wherein the sum of all ingredients always adds up to 100 wt %.
wherein the polyolefin composition has
   a melt flow rate MFR₂ (230° C., 2.16 kg, measured according to ISO 1133) of at least 0.3 g/10 min; and
   an impact strength (ISO179-1, Charpy 1eA+23° C.) of at least 15 kJ/m².

Thus, a polyolefin composition is provided that comprises recycled plastic material and virgin heterophasic polypropylene polymer. This combination provides a composition wherein at least a part of virgin polymer is replaced by recycled material, wherein properties such as fatigue crack growth rate can be almost comparable to the virgin polymers. Such compositions are applicable for pipes, for example high-pressure pipes.

The present recyclate-containing polyolefin composition is characterized by a fatigue crack growth rate and/or an impact strength that are comparable to the virgin heterophasic polypropylene copolymer. The performance of the combination of the different kinds of polymers and recyclates is not easily predictable. It is challenging to predict fatigue crack growth rate and/or impact strength due to the interaction between the various components. Also, recyclate polyolefins are typically contaminated with polar polymers (e.g., PA, and/or PET) and/or other non-POs such as PS or fillers etc., which make an obvious calculation of the final mechanical performance still more challenging.

It is to be understood that the present polyolefin composition does not comprise talc, glass fibers, compatibilizer, HDPE and/or rubber—except any amounts of such components present in the recyclate.

As used herein, the term “recycled” indicates that the material is recovered from post-consumer waste and/or post-industrial waste. Namely, post-consumer waste refers to objects having completed at least a first use cycle (or life cycle), i.e., having already served their first purpose and been through the hands of a consumer; while post-industrial waste refers to the manufacturing scrap which does normally not reach a consumer. The “recycled polymers” may also comprise up to 17 wt.-%, or up to 3 wt.-%, or up to 1 wt.-% or up to 0.1 wt.-% based on the overall weight of the recycled polymer of other components originating from the first use. Type and amount of these components influence the physical properties of the recycled polymer. The physical properties given below refer to the main component of the recycled polymer.

As described also further below, typical other components originating from the first use are thermoplastic polymers, for example polystyrene and/or PA 6, talc, chalk, ink, wood, paper, limonene and/or fatty acids. The content of polystyrene (PS)/or polyamide 6 (PA 6) in recycled polymers can be determined by Fourier Transform Infrared Spectroscopy (FTIR) and the content of talc, chalk, wood and/or paper may be measured by Thermogravimetric Analysis (TGA).

The term “virgin” denotes the newly produced materials and/or objects prior to first use and not being recycled. In case that the origin of the polymer is not explicitly mentioned the polymer is a “virgin” polymer.

In some non-limiting embodiments the polyolefin composition comprises
a) 70-90 wt % (based on the overall weight of the polyolefin composition) of at least one heterophasic propylene copolymer (HECO) with a total ethylene (C2) content (as determined according to CRYSTEX QC analysis) of 0.5 to 4.5 wt.-%, and a xylene cold soluble fraction (determined at 25° C. according to ISO 16152) of 2-9 wt % and a melt flow rate MFR₂ (ISO 1133, 2.16 kg, 230° C., measured according to ISO 1133) of 0.1 to 1 g/10 min,
b) 10-30 wt % (based on the overall weight of the polyolefin composition) of a mixed-plastics polypropylene blend of recycled material having an ethylene (C2) content determined according to CRYSTEX QC analysis of 5 to 35 wt %, and
c) optionally further additives, wherein the sum of all ingredients always adds up to 100 wt %.

It is to be understood that the amounts of heterophasic propylene copolymer (HECO) and polypropylene recyclate are always complementary to each other. For example, the composition may comprise in some non-limiting embodiments 70 wt % heterophasic propylene copolymer (HECO) and 30 wt % polypropylene recyclate, or in some non-limiting embodiments 80 wt % heterophasic propylene copolymer (HECO) and 20 wt % polypropylene recyclate.

In some non-limiting embodiments, the polyolefin composition may comprise
65 wt % heterophasic propylene copolymer (HECO) and 35 wt % polypropylene recyclate;
70 wt % heterophasic propylene copolymer (HECO) and 30 wt % polypropylene recyclate;
75 wt % heterophasic propylene copolymer (HECO) and 25 wt % polypropylene recyclate;
80 wt % heterophasic propylene copolymer (HECO) and 20 wt % polypropylene recyclate;
85 wt % heterophasic propylene copolymer (HECO) and 15 wt % polypropylene recyclate;
90 wt % heterophasic propylene copolymer (HECO) and 10 wt % polypropylene recyclate; or
95 wt % heterophasic propylene copolymer (HECO) and 5 wt % polypropylene recyclate.

It is to be understood that small amounts of additives, such as antioxidants, may be present in the compositions disclosed herein. The sum of all ingredients always add up to 100%.

In some non-limiting embodiments, the polyolefin composition has a melt flow rate MFR₂ (2.16 kg, 230° C., measured according to ISO 1133) of 0.3 to 1 g/10 min, or 0.4 to 0.8 g/10 min, or 0.5 to 0.7 g/10 min.

In some non-limiting embodiments, the polyolefin composition has an impact strength (ISO179-1, Charpy 1eA+23° C.) of at least 17 kJ/m², or at least 19 kJ/m², or at least 20 kJ/m², or 15 to 25 kJ/m², or 17 to 23 kJ/m², or 19 to 21 kJ/m².

In case of a polyolefin composition comprising 8-12 wt %, or 10 wt %, of polypropylene recyclate, the impact strength is 18 to 23 kJ/m², or 19 to 22 kJ/m², or 20 to 21 kJ/m².

In case of a polyolefin composition comprising 18-22 wt %, or 20 wt %, of polypropylene polyethylene recyclate, the impact strength is 17 to 22 kJ/m², or 18 to 21 kJ/m², or 19 to 20 kJ/m².

In case of a polyolefin composition comprising 28-32 wt %, or 30 wt % polypropylene polyethylene recyclate, the impact strength is 15 to 20 kJ/m², or 16 to 19 kJ/m², or 17 to 18 kJ/m².

In some non-limiting embodiments, the polyolefin composition has a ΔK_{I} as an indicator for fatigue crack growth resistance (derived from CRB testing according to ISO 18489:2015) of more than 0.8, or more than 0.9, or more than 0.95, or more than 1.0 MPa*m^{0.5} at 8E5 cycles, or a suitable limit of ΔK_{I} would be 1.5, or 1.3, or 1.2 MPa*m^{0.5} at 8E5 cycles.

The value of ΔK_{I} at 8E5 cycles of the present polyolefin composition may vary depending on the amount of polypropylene recyclate added to the composition.

In some non-limiting embodiments, for example, if 8-12 wt %, or 10 wt %, of polypropylene recyclate are added the ΔK_{I} value of the final polyolefin composition may be more than 1.05, or more than 1.07 MPa*m^{0.5} at 8E5 cycles.

In some non-limiting embodiments, if 18-22 wt %, or 20 wt %, of polypropylene recyclate are added the ΔK_{I} value of the final polyolefin composition may be more than 0.98, or more than 1.00, or more than 1.02 MPa*m^{0.5} at 8E5 cycles.

In some non-limiting embodiments, if 28-32 wt %, or 30 wt %, of polypropylene recyclate are added the ΔK_{I} value of the final polyolefin composition may be more than 0.90, or more than 0.95 MPa*m^{0.5} at 8E5 cycles.

In some non-limiting embodiments, the present polyolefin composition has a Youngs module of 1500-1800 MPa, or 1600-1700 MPa; a Yield strength of 30-40 MPa, or 33-36 MPa and/or a strain-at-break of 50-200%, or 60-150%, or 70-115%.

In some non-limiting embodiments, the present polyolefin composition has a density of 0.9-0.95 g/cm³, or 0.91-0.92 g/cm³.

In some non-limiting embodiments, the present polyolefin composition has a PP enthalpy of 75-110 J/g, or 95-105 J/g, a PE enthalpy of 0.02-3.0 J/g, or 0.02-0.3 J/g, PP T_{M} of 165-167° C. and/or a PE T_{M} of 122-126° C., or 122-124° C.

In some non-limiting embodiments, the polyolefin composition comprises
a) 70-90 wt % (based on the overall weight of the polyolefin composition) of at least one heterophasic propylene copolymer (HECO) with a total ethylene (C2) content (as determined according to CRYSTEX QC analysis) of 0.5 to 4.5 wt. %, and a xylene cold soluble fraction (determined at 25° C. according to ISO 16152) of 2-9 wt %, a melt flow rate MFR₂ (ISO 1133, 2.16 kg, 230° C., measured according to ISO 1133) of 0.1 to 1 g/10 min,
b) 10-30 wt % (based on the overall weight of the polyolefin composition) of a mixed-plastics polypropylene blend of recycled material having an ethylene (C2) content determined according to CRYSTEX QC analysis of 5 to 10 wt %, and
c) optionally further additives, wherein the sum of all ingredients always adds up to 100 wt %,
wherein the polyolefin composition has
   a melt flow rate MFR₂ (230° C., 2.16 kg, measured according to ISO 1133) of 0.3 to 1 g/10 min, or 0.4 to 0.8 g/10 min, or 0.5 to 0.7 g/10 min,
   an impact strength (ISO179-1, Charpy 1eA+23° C.) of 17 to 23 kJ/m², or 19 to 21 kJ/m²,
   and/or a ΔK_{I}(derived from Cracked round bar testing according to ISO 18489:2015) of more than 0.9, or more than 0.95, or more than 1.0 MPa*m^{0.5} at 8E5 cycles.

In some non-limiting embodiments, the polyolefin composition comprises
a) 70-90 wt % (based on the overall weight of the polyolefin composition) of at least one heterophasic propylene copolymer (HECO) with a total ethylene (C2) content (as determined according to CRYSTEX QC analysis) of 0.5 to 4.5 wt.-%, and a xylene cold soluble fraction (determined at 25° C. according to ISO 16152) of 2-9 wt % and a melt flow rate MFR₂ (ISO 1133, 2.16 kg, 230° C., measured according to ISO 1133) of 0.1 to 1 g/10 min,
b) 10-30 wt % (based on the overall weight of the polyolefin composition) of a mixed-plastics polypropylene blend of recycled material having an ethylene (C2) content determined according to CRYSTEX QC analysis of 5 to 10 wt %, and C2 (CF) content of the crystalline faction as determined according to CRYSTEX QC analysis, of lower than 5 wt %,
c) optionally further additives, wherein the sum of all ingredients always adds up to 100 wt %,
wherein the polyolefin composition has
   a melt flow rate MFR₂ (230° C., 2.16 kg, measured according to ISO 1133) of 0.3 to 1 g/10 min, or 0.4 to 0.8 g/10 min, or 0.5 to 0.7 g/10 min,
   an impact strength (ISO179-1, Charpy 1eA+23° C.) of 17 to 23 kJ/m², or 19 to 21 kJ/m²,
   and/or a ΔK_{I}(derived from Cracked round bar testing according to ISO 18489:2015) of more than 0.9, or more than 0.95, or more than 1.0 MPa*m^{0.5} at 8E5 cycles.

Heterophasic polypropylene virgin polymer (HECO) Heterophasic polypropylene copolymers comprise as polymer components a polypropylene matrix (M) and an elastomeric copolymer (EPC). In some non-limiting embodiments, the at least one heterophasic propylene copolymer (HECO) comprises a propylene homopolymer (PPH) as (semicrystalline) matrix and a propylene-ethylene rubber as elastomeric propylene copolymer (EPC).

In some non-limiting embodiments, the polypropylene matrix (M) is a random propylene copolymer or a propylene homopolymer, the latter being preferred. The expression “propylene homopolymer relates to a polypropylene that consists of more than 99.5 wt %, or more than or at least of 99.7 wt % of propylene units. In some non-limiting embodiments, only propylene units are detectable in the propylene homopolymer.

The elastomeric propylene copolymer (EPC) comprises units derived from propylene and ethylene and/or C4 to C20 alpha-olefins, or from ethylene and/or C4 to C10 alpha-olefins, or from ethylene, C4, C6 and/or C8 alpha-olefins, e.g. ethylene and, optionally, units derived from a conjugated diene.

In some non-limiting embodiments, the at least one heterophasic propylene copolymer (HECO) comprises a propylene homopolymer and a propylene-ethylene rubber as elastomeric propylene copolymer.

The amount of elastomeric propylene copolymer (EPC) is typically equivalent with the xylene cold soluble (XCS) fraction. The presently used heterophasic propylene copolymer (HECO-1) has a xylene cold soluble fraction determined at 25° C. according to ISO 16152 of 2.5 to 8.5 wt %, or 3.0 to 8.0 wt %, or 4.0 to 7.0 wt %.

The heterophasic propylene copolymer (HECO) has a total ethylene (C2) content, as determined according to CRYSTEX QC analysis, of 1.0 to 4.0 wt.-%, or 1.0 to 3.0 wt.-%, or 1.0 to 2.0 wt.-%.

The heterophasic propylene copolymer (HECO-1) of the present disclosure has a content of soluble fraction (SF), determined according to CRYSTEX analysis, of 2.0 to 10.0 wt. %, of 3.0 to 8.0 wt. %, or 4.0 to 7.0 wt %, or 5.0 to 6.0 wt % based on the total weight of the heterophasic propylene copolymer.

The soluble fraction (SF) of the heterophasic propylene copolymer (HECO-1) has an ethylene content (C2(SF)), as determined according to CRYSTEX QC analysis, of 10.0 to 30.0 wt. %, or 15.0 to 25.0 wt. %, or 18.0 to 22.0 wt. %.

The soluble fraction (SF) of the heterophasic propylene copolymer (HECO-1) has an intrinsic viscosity (iV(SF)) of not more than 3.0 dl/g, or not more than 3.5 dl/g, or 2.0 to 4.0 dl/g, or 3.2 to 4.0 dl/g, or 3.5 dl/g.

The crystalline fraction (CF) of the heterophasic propylene copolymer (HECO-1) has an ethylene content (C2(CF)), as determined according to CRYSTEX QC analysis, of 0.1 to 2.0 wt. %, or 0.2 to 1.0 wt. %, or 0.3 to 0.5 wt. %.

The crystalline fraction (CF) of the heterophasic propylene copolymer (HECO-1) has an intrinsic viscosity (iV(CF)) of not more than 3.5 dl/g, or not more than 4.0 dl/g, or 3.0 to 6.0 dl/g, or 4.0 to 5.0 dl/g.

The at least one heterophasic propylene copolymer (HECO-1) has a melt flow rate MFR₂ (ISO 1133, 2.16 kg, 230° C., measured according to ISO 1133) of 0.1 to 0.9 g/10 min, or 0.15 to 0.8 g/10 min, or 0.2 to 0.7 g/10 min.

It is to be understood that the present polyolefin composition may comprise not only one, but two heterophasic virgin propylene copolymers with different melt flow rates. This allows for an adjustment of the melt flow rate of the final polyolefin composition.

The at least one heterophasic propylene copolymer (HECO-1) has an impact strength (ISO179-1, Charpy 1eA+23° C.) of at least 20 kJ/m², or at least 25 kJ/m², or at least 30 kJ/m², or 20 to 40 kJ/m², or 25 to 38 kJ/m², or 30 to 35 kJ/m².

The virgin heterophasic polypropylene copolymer (HECO-1) may have a tensile Young's modulus measured according to ISO 527-2 of at least 1800 MPa, or at least 1830 MPa, or 1800 to 2100 MPa, or 1830 to 2050 MPa.

The heterophasic propylene copolymer (HECO-1) may have a Yield strength of 30-40 MPa, or 33-37 MPa and a strain-at-break of 40-50%, or 44-46%.

### Mixed-Plastics Polypropylene Blend of Recycled Material

The mixed-plastics polypropylene blend is obtained from recycled waste stream of either recycled post-consumer waste or post-industrial waste, such as for example from the automobile industry, or alternatively, a combination of both. It is preferred that the recyclate consists of recycled post-consumer waste and/or post-industrial waste.

In some non-limiting embodiments, the recyclate blend may be a polypropylene (PP) rich material of recycled plastic material that comprises significantly more polypropylene than polyethylene. Recycled waste streams, which are high in polypropylene, can be obtained for example from the automobile industry, as some automobile parts such as bumpers are sources of fairly pure polypropylene material in a recycling stream or by enhanced sorting. The PP rich material may be obtained by selective processing, degassing and filtration and/or by separation according to type and colors such as NIR or Raman sorting and/or VIS sorting. It may be obtained from domestic waste streams (i.e., it is a product of domestic recycling) for example the “yellow bag” recycling system organized under the “Green dot” organization, which operates in some parts of Germany.

In some non-limiting embodiments, the polypropylene rich recycled material is obtained from recycled waste by means of plastic recycling processes known in the art. Such PP rich recyclates are commercially available, e.g., from Corepla (Italian Consortium for the collection, recovery, recycling of packaging plastic wastes), Resource Plastics Corp. (Brampton, ON), Kruschitz GmbH, Plastics and Recycling (AT), Vogt Plastik GmbH (DE), Mtm Plastics GmbH (DE), etc. Non-limiting examples of polypropylene rich recycled materials include: Dipolen® PP, Purpolen® PP (Mtm Plastics GmbH), Axpoly® recycled polypropylene pellets (Axion Ltd) and PolyPropylene Copolymer (BSP Compounds). It is considered that the present disclosure could be applicable to a broad range of recycled polypropylene materials or materials or compositions having a high content of recycled polypropylene. The polypropylene-rich recycled material may be in the form of granules.

In some non-limiting embodiments, the mixed-plastics polypropylene blend of recycled material has an ethylene C2 content (as determined according to CRYSTEX QC analysis) of 5 to 20 wt %, or 5 to 10 wt %. The use of a propylene recyclate with a C2 content of less than 10 wt % is preferred.

The C2 (SF) content of the soluble fraction of the recyclate blend, as determined according to CRYSTEX QC analysis, is 25-35 wt %, or 27-33 wt %, or 29-31 wt %.

The C2 (CF) content of the crystalline faction of the recyclate blend, as determined according to CRYSTEX QC analysis, is 1-35 wt %, or 2-20 wt %, or 4-10 wt %, or lower than 5 wt %, or 1 to 5 wt %. The use of a recyclate blend with a C2 (CF) content of lower than 5 wt %, such as 4.5 wt % is preferred.

In some non-limiting embodiments, the mixed-plastics polypropylene blend of recycled material has a melt flow rate (ISO1133, 2.16 kg; 230° C.) of 5 to 30 g/10 min, or 10 to 20 g/10 min, or 12 to 18 g/10 min or 13 to 17 g/10 min. The use of a propylene recyclate with a melt flow rate of 13 to 16 g/10 min is preferred.

The mixed-plastics polypropylene blend of recycled material has an impact strength (1S0179-1, Charpy 1eA+23° C.) of at least 4 kJ/m², or at least 5 kJ/m², or at least 6 kJ/m², or 4 to 15 kJ/m², or 5 to 10 kJ/m², or 6 to 8 kJ/m². The use of a propylene recyclate with an impact strength or 6 to 7 kJ/m² is preferred.

In some non-limiting embodiments, the recyclate blend has a Young's modulus of 1000-1400 MPa, or 1100-1300 MPa; a Yield strength of 20-30 MPa, or 25-28 MPa and a strain-at-break of 10-50%, or 30-50%, or 35-45%, or 39% or 46%.

In some non-limiting embodiments, the mixed-plastics polypropylene blend of recycled material comprises further components selected from the group comprising polystyrene, stabilizers, polyamide, talc, chalk, paper, wood, metal, limonene, fatty acid and mixtures thereof, for example polystyrene, polyamide-6 as determined by FTIR, limonene as determined by using solid phase microextraction (HS-SPME-GC-MS), and/or chalk.

Due to the recycling origin, the blend may comprise: organic fillers, and/or inorganic fillers, and/or additives in amounts of up to 10 wt %, or up to 3 wt % with respect to the weight of the blend.

As stated above, the recyclate blend may comprise one or more further components, selected from:
up to 3.0 wt %, or up to 2.0 wt % of polystyrene and/or copolymers such as ABS,
up to 3.0 wt % stabilizers, or up to 2.0 wt % stabilizers,
up to 4.0 wt % polyamide, or up to 2.0 wt % polyamide,
up to 3.0 wt % talc, or up to 1.0 wt % talc,
up to 1.0 wt % paper, or up to 0.5 wt % paper,
up to 1.0 wt % wood, or up to 0.5 wt % wood, and
up to 0.5 wt % metal, or up to 0.1 wt % metal,
0.1 ppm-100 ppm of limonene as determined by using solid phase microextraction (HS-SPME-GC-MS), and
0-200 ppm total fatty acid content as determined by using solid phase microextraction (HS-SPME-GC-MS), wherein all amounts are given with respect to the total weight of the recyclate blend.

Non-limiting examples of properties of different recyclate blends that may be used are now described.

Blend A1: C2 content 8-9 wt %, C2 (CF) content 7-8 wt %, C2 (SF) content 29-30 wt %, intrinsic viscosity 1.6-1.7 dL/g; MFR₂ 15-16 g/10 min, Young's modulus 1100-1200 MPa, Impact strength (charpy test 23° C.) 6-7 KJ/m².

Blend A2: C2 content 7-8 wt %, C2 (CF) content 4-5 wt %, C2 (SF) content 30-31 wt %, intrinsic viscosity 1.7-1.8 dL/g; MFR₂ 13-14 g/10 min, Young's modulus 1300-1400 MPa, Impact strength (charpy test 23° C.) 6-7 KJ/m².

Blend A3: C2 content 32-33 wt %, C2 (CF) content 31-32 wt %, C2 (SF) content 34-35 wt %, intrinsic viscosity 1.8-1.9 dL/g; MFR₂ 9-10 g/10 min, Young's modulus 1000-1100 MPa, Impact strength (charpy test 23° C.) 5-6 KJ/m².

It is to be understood that Blend A1 and Blend A2 are preferred, wherein Blend A2 is the a preferred blend used in the present polyolefin composition.

### Additives

Examples of additives for use in the present polyolefin composition are pigments and/or dyes (for example carbon black), stabilizers (anti-oxidant agents), anti-acids and/or anti-UVs, antistatic agents, nucleating agents and/or utilization agents (such as processing aid agents). Preferred additives are carbon black, at least one antioxidant and/or at least one UV stabilizer.

Generally, the amount of these additives is 0 to 5.0 wt %, or 0.01 to 3.0 wt %, or 0.01 to 2.0 wt % based on the weight of the total polyolefin composition.

Non-limiting examples of antioxidants which are commonly used in the art comprise sterically hindered phenols (such as CAS No. 6683-19-8, also sold as Irganox 1010 FF™ by BASF), phosphorous based antioxidants (such as CAS No. 31570-04-4, also sold as Hostanox PAR 24 (FF)™ by Clariant, or Irgafos 168 (FF)™ by BASF), sulphur based antioxidants (such as CAS No. 693-36-7, sold as Irganox PS-802 FL™ by BASF), nitrogen-based antioxidants (such as 4,4′-bis(1,1′-dimethylbenzyl)diphenylamine), or antioxidant blends. Preferred antioxidants may be Tris (2,4-di-t-butylphenyl) phosphite and/or Octadecyl 3-(3′,5′-di-tert. butyl-4-hydroxyphenyl)propionate.

Non-limiting examples of anti-acids are also commonly known in the art. Examples comprise calcium stearates, sodium stearates, zinc stearates, magnesium and/or zinc oxides, synthetic hydrotalcite (e.g. SHT, CAS-No. 11097-59-9), lactates and/or lactylates, as well as calcium stearate (CAS No. 1592-23-0) and/or zinc stearate (CAS No. 557-05-1).

Non-limiting examples of common antiblocking agents comprise natural silica such as diatomaceous earth (such as CAS No. 60676-86-0 (SuperfFloss™), CAS-No. 60676-86-0 (SuperFloss E™), or CAS-No. 60676-86-0 (Celite 499™)), synthetic silica (such as CAS-No. 7631-86-9, CAS-No. 7631-86-9, CAS-No. 7631-86-9, CAS-No. 7631-86-9, CAS-No. 7631-86-9, CAS-No. 7631-86-9, CAS-No. 112926-00-8, CAS-No. 7631-86-9, or CAS-No. 7631-86-9), silicates (such as aluminium silicate (Kaolin) CAS-no. 1318-74-7, sodium aluminum silicate CAS-No. 1344-00-9, calcined kaolin CAS-No. 92704-41-1, aluminum silicate CAS-No. 1327-36-2, and/or calcium silicate CAS-No. 1344-95-2), synthetic zeolites (such as sodium calcium aluminosilicate hydrate CAS-No. 1344-01-0, CAS-No. 1344-01-0, and/or sodium calcium aluminosilicate, hydrate CAS-No. 1344-01-0).

Non-limiting examples of anti-UVs comprise, for example, Bis-(2,2,6,6-tetramethyl-4-piperidyl)-sebacate (CAS-No. 52829-07-9, Tinuvin 770); and/or 2-hydroxy-4-n-octoxy-benzophenone (CAS-No. 1843-05-6, Chimassorb 81). Preferred UV stabilizers may be low and/or high molecular weight UV stabilizers such as n-Hexadecyl-3,5-di-t-butyl-4-hydroxybenzoate, or a mixture of esters of 2,2,6,6-tetramethyl-4-piperidinol and higher fatty acids (mainly stearic acid) and/or Poly((6-morpholino-s-triazine-2,4-diyl)(1,2,2,6,6-pentamethyl-4-piperidyl)imino)hexameth-ylene (1,2,2,6,6-pentamethyl-4-piperidyl)imino)).

Non-limiting examples of alpha nucleating agents comprise sodium benzoate (CAS No. 532-32-1); and/or 1,3:2,4-bis(3,4-dimethylbenzylidene)sorbitol (CAS 135861-56-2, Millad 3988). Non-limiting examples of antistatic agents comprise, for example, glycerol esters (CAS No. 97593-29-8) and/or ethoxylated amines (CAS No. 71786-60-2 or 61791-31-9) and/or ethoxylated amides (CAS No. 204-393-1).

Usually, these additives are added in quantities of 100-2.000 ppm for each individual component of the polymer.

It is appreciated that the present disclosure also refers to a process for producing the polyolefin compositions as disclosed herein.

The process comprises the steps of
providing a mixture of 60-95 wt % (based on the total weight of the polyolefin composition) of the at least one heterophasic propylene copolymer (HECO) with a total ethylene (C2) content (as determined according to CRYSTEX QC analysis) from 0.5 to 4.5 wt.-%, and a xylene cold soluble fraction (determined at 25° C. according to ISO 16152) of 2-9 wt % and a melt flow rate MFR₂ (ISO 1133, 2.16 kg, 230° C., measured according to ISO 1133) of 0.1 to 1 g/10 min; and 5-40 wt % (based on the overall weight of the polyolefin composition) of a mixed-plastics polypropylene blend of recycled material having an ethylene (C2) content (as determined according to CRYSTEX QC analysis) of 5 to 35 wt %, and optionally further additives,
melting the mixture in an extruder, and
optionally pelletizing the obtained polyolefin composition

For the purposes of the present disclosure, any suitable melting and mixing means known in the art may be used for carrying out the mixing and melting.

However, in some non-limiting embodiments, the melting and mixing step takes place in a mixer and/or blender, high or low shear mixer, high-speed blender, or a twin-screw extruder, or preferably, the melting and mixing step takes place in a twin-screw extruder such as a co-rotating twin-screw extruder. Such twin-screw extruders are well known in the art and the skilled person will adapt the melting and mixing conditions (such as melting temperature, screw speed and the like) according to the process equipment.

The polyolefin composition according to the disclosure can be used for a wide range of applications, for example in the manufacture of structural products, appliances, pipes, roofing applications, or for pipes. Thus, another subject of the present disclosure is an article, for example a pipe, comprising the polyolefin composition as disclosed herein.

### BRIEF DESCRIPTION OF THE DRAWING

The present disclosure is now explained in more detail with reference to the examples and figure.

FIG. 1 shows a diagram illustrating ΔK_{I}[MPa*m^{0.5}] at 8E5 cycles for the fatigue crack growth over melt flow rate [g/10 min] of comparative examples and inventive examples.

### DETAILED DESCRIPTION

### Experimental Section

The following non-limiting examples are included to demonstrate certain aspects and embodiments of the disclosure as described in the claims. It should be appreciated by those of skill in the art, however, that the following description is illustrative only and should not be taken in any way as a restriction of the disclosure.

### I. Analytical Methods

Amount of “iPP”, “PVC”, “PA”, “PET”, “PS” and “PE” determination by Transmission Infra-Red spectroscopy

### Sample Preparation:

All calibration samples and samples to be analyzed are prepared in similar way, on molten pressed plates.

Around 2 to 3 g of compounds to be analyzed are molten at 190° C. Subsequently, for 20 seconds 60 to 80 bar pressure is applied in a hydraulic heating press. Next, the samples are cooled down to room temperature in 40 second in a cold press under the same pressure, in order to control the morphology of the compound. The thickness of the plates are controlled by metallic calibrated frame plates 2.5 cm by 2.5 cm, 100 to 200 μm thick (depending MFR from the sample); two plates are produced in parallel at the same moment and in the same conditions. The thickness of each plate is measured before any FTIR measurements; all plates are between 100 to 200 μm thick.

To control the plate surface and to avoid any interference during the measurement, all plates are pressed between two double-sided silicone release papers.

In case of powder samples or heterogeneous compounds, the pressing process would be repeated three times to increase homogeneity by pressed and cutting the sample in the same conditions as described before.

### Spectrometer:

Standard transmission FTIR spectroscope such as Bruker Vertex 70 FTIR spectrometer is used with the following set-up:
a spectral range of 4000-400 cm⁻¹,
an aperture of 6 mm,
a spectral resolution of 2 cm⁻¹,
with 16 background scans, 16 spectrum scans,
an interferogram zero filling factor of 32
Norton Beer strong apodisation.

Spectrum are recorded and analyzed in Bruker Opus software.

### Calibration Samples:

As FTIR is a secondary method, several calibration standards were compounded to cover the targeted analysis range, typically from:
0.2 wt % to 2.5 wt % for PA
0.1 wt % to 5 wt % for PS
0.2 wt % to 2.5 wt % for PET
0.1 wt % to 4 wt % for PVC

The following commercial materials were used for the compounds: Borealis HC600TF as iPP, Borealis FB3450 as HDPE and for the targeted polymers such RAMAPET N1S (Indorama Polymer) for PET, Ultramid® B36LN (BASF) for Polyamide 6, Styrolution PS 486N (Ineos) for High Impact Polystyrene (HIPS), and for PVC Inovyn PVC 263B (under powder form).

All compounds are made at small scale in a Haake kneader at a temperature below 265° C. and less than 10 minutes to avoid degradation.

Additional antioxidant such as Irgafos 168 (3000 ppm) is added to minimize the degradation.

### Calibration:

The FTIR calibration principal is the same for all the components: the intensity of a specific FTIR band divided by the plate thickness is correlated to the amount of component determined by 1H or 13C solution state NMR on the same plate.

Each specific FTIR absorption band is chosen due to its intensity increase with the amount of the component concentration and due to its isolation from the rest of the peaks, whatever the composition of the calibration standard and real samples.

This methodology is described in the publication from Signoret and al. “Alterations of plastic spectra in MIR and the potential impacts on identification towards recycling”, Resources, conservation and Recycling journal, 2020, volume 161, article 104980, incorporated by reference herein.

The wavelength for each calibration band is:
3300 cm⁻¹ for PA,
1601 cm⁻¹ for PS,
1410 cm⁻¹ for PET,
615 cm⁻¹ for PVC,
1167 cm⁻¹ for iPP.

For each polymer component i, a linear calibration (based on linearity of Beer-Lambert law) is constructed. A typical linear correlation used for such calibrations is given below:

$${x}_{i} = {A}_{i} \cdot \frac{{E}_{i}}{d} + {B}_{i}$$

where xᵢ is the fraction amount of the polymer component i (in wt %).

Eᵢ is the absorbance intensity of the specific band related to the polymer component i (in a.u. absorbance unit). These specific bands are, 3300 cm⁻¹ for PA, 1601 cm⁻¹ for PS, 1410 cm⁻¹ for PET, 615 cm⁻¹ for PVC, 1167 cm⁻¹ for iPP.

d is the thickness of the sample plate

Aᵢ and Bᵢ are two coefficients of correlation determined for each calibration curve

No specific isolated band can be found for C2 rich fraction and as a consequence the C2 rich fraction is estimated indirectly,

$${x}_{C 2 rich} = 100 - ( {x}_{iPP} + {x}_{PA} + {x}_{PS} + {x}_{PET} + {x}_{EVA} + {x}_{PVC} + {x}_{chalk} + {x}_{talc} )$$

The EVA, Chalk and Talc contents are estimated “semi-quantitatively”. Hence, this renders the C2 rich content “semi-quantitative”.

The following bands are used to estimate the EVA, Chalk and Talc contents:
EVA: band centred at 607 cm−1
Chalk: band centred at 1798 cm−1
Talc: band centred at 3676 cm−1

In addition, the presence of titanium di-oxide, TiO₂ and Carbon Black are reported. Their quantifications are not feasible with FTIR.

For each calibration standard, wherever available, the amount of each component is determined by either ¹H or ¹³C solution state NMR, as primary method (except for PA). The NMR measurements are performed on the exact same FTIR plates used for the construction of the FTIR calibration curves.

Amount of Talc and Chalk were measured by Thermogravimetric Analysis (TGA). Experiments were performed with a Perkin Elmer TGA 8000. Approximately 10-20 mg of material was placed in a platinum pan. The temperature was equilibrated at 50° C. for 10 minutes, and afterwards raised to 950° C. under nitrogen at a heating rate of 20° C./min. The weight loss between ca. 550° C. and 700° C. (WCO2) was assigned to CO₂ evolving from CaCO₃, and therefore the chalk content was evaluated as:

Chalk content=100/44×WCO2

Afterwards the temperature was lowered to 300° C. at a cooling rate of 20° C./min. Then the gas was switched to oxygen, and the temperature was raised again to 900° C. The weight loss in this step was assigned to carbon black (Wcb). Knowing the content of carbon black and chalk, the ash content excluding chalk and carbon black was calculated as:

Ash content=(Ash residue)−56/44×WCO2−Wcb

Where Ash residue is the weight % measured at 900° C. in the first step conducted under nitrogen. The ash content is estimated to be the same as the talc content for the investigated recyclates.

### Amount of Paper, Wood

Paper and wood were determined by conventional laboratory methods including milling, floatation, microscopy and Thermogravimetric Analysis (TGA) or floating techniques.

Amount of Metals was determined by x ray fluorescence (XRF).

Amount of Limonene was determined by solid phase microextraction (HS-SPME-GC-MS).

Additional details are given below with respect to the specific sample.

### Amount of Total Fatty Acids

was determined by solid phase microextraction (HS-SPME-GC-MS).

Xylene Cold Solubles (XCS) were measured at 25° C. according ISO 16152; first edition; 2005-07-01.

Crystex Analysis: Crystalline and Soluble Fractions and their Respective Properties

The crystalline (CF) and soluble fractions (SF) of the polypropylene (PP) compositions as well as the comonomer content and intrinsic viscosities of the respective fractions were analyzed by the CRYSTEX QC Polymer Char (Valencia, Spain).

A schematic representation of the CRYSTEX QC instrument is presented in Del Hierro, P.; Ortin, A.; Monrabal, B.; ‘Soluble Fraction Analysis in polypropylene, The Column, February 2014. Pages 18-23. The crystalline and amorphous fractions are separated through temperature cycles of dissolution at 160° C., crystallization at 40° C. and re-dissolution in 1,2,4-trichlorobenzene (1,2,4-TCB) at 160° C. Quantification of SF and CF and determination of ethylene content (C2) are achieved by means of an infrared detector (IR4) and an online 2-capillary viscometer is used for determination of the intrinsic viscosity (IV).

IR4 detector is a multiple wavelength detector detecting IR absorbance at two different bands (CH3 and CH2) for the determination of the concentration and the Ethylene content in Ethylene-Propylene copolymers. IR4 detector is calibrated with series of EP copolymers with known Ethylene content in the range of 2 wt. % to 69 wt. % (determined by 13C-NMR).

Amounts of Soluble fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 Wt %.

Intrinsic viscosity (IV) of the parent EP copolymer and its soluble and crystalline fractions are determined with a use of an online 2-capillary viscometer and are correlated to corresponding IV's determined in decalin according to ISO 1628.

Calibration is achieved with several commercial EP PP copolymers with IV=2-4 dL/g.

A sample of the PP composition to be analyzed is weighed out in concentrations of 10 mg/ml to 20 mg/ml. After automated filling of the vial with 1,2,4-TCB containing 250 mg/I 2,6-tert-butyl-4-methylphenol (BHT) as antioxidant, the sample is dissolved at 160° C. until complete dissolution is achieved, usually for 60 min, with constant stirring of 800 rpm.

A defined volume of the sample disclosure is injected into the column filled with inert support where the crystallization of the sample and separation of the soluble fraction from the crystalline part is taking place. This process is repeated two times. During the first injection the whole sample is measured at high temperature, determining the IV [dl/g] and the C2 [wt %] of the PP composition. During the second injection the soluble fraction (at low temperature) and the crystalline fraction (at high temperature) with the crystallization cycle are determined (Wt % SF, Wt % C2, IV).

### II. Test Methods

The following definitions of terms and determination methods apply for the above general description of the disclosure as well as to the below examples unless otherwise defined.

### Production of Multipurpose Specimens (MPS) and Charpy Type 1 Specimen

All MPS were produced via injection molding according to ISO 3167 (Plastics—Multipurpose test specimens) and ISO 19069-2 (Plastics—Polypropylene (PP) molding and extrusion materials—Part 2: Preparation of test specimens and determination of properties) on an Engel Victory 60 (Engel, Austria). Specimens were conditioned at 23° C. and 50% relative humidity for at least three days. After conditioning, these specimens were used for tensile testing and for subsequent cutting and notching to Type 1 specimens for Charpy notched impact testing according to ISO 179-1 (see more information about the test later).

### Production of CRB Specimen

CRB specimens were produced according to ISO 18489 but with a slight adaptation for the different material. Therefore, plates in the size of 16 mm×120 mm×150 mm were pressed in a positive mold at 210° C. More specifically, a hydraulic press of the Langzauner Perfect line (Langzauner, Austria) was used. Within the fully automated program, 270 g granules are heated within the mold to 210° C. with the weight of the mold and cylinder on top of them. An integrated temperature sensor allows for direct measurement of the granules or melt, respectively. When the temperature of 210° C. is reached, it is held isothermal for 15 minutes. After that, the slow cooling with a cooling rate of 2 K/min is started. Depending on the viscosity of the specimen, the full pressure of 10 MPa is applied to the granules at temperatures from 165° C. After reaching 40° C., the pressure is released, the mold is opened, and the plate can be removed.

The produced plates were conditioned at 23° C. and 50% relative humidity for at least three days before being cut into bars on a table saw and lathed on a turning lathe to CRB specimens according to ISO 18389. A 0.3 mm thick industrial grade razor blade was used to notch the specimen. The specimens were conditioned at 23° C. and 50% relative humidity for another day after being notched before being tested.

### Melt Flow Rate (MFR)

The MFR measurements were conducted at 230° C. and with 2.16 kg on a Zwick/Roell Mflow melt flow indexer (Zwick Roell, Germany) according to ISO 1133-1 (Plastics—Determination of the melt mass-flow rate (MFR) and melt volume-flow rate (MVR) of thermoplastics—Part 1: Standard method). Cuts were made every 3 mm piston movement. The time between cuts was measured and each extrudate was weighted on an ABS 220-4 electronic balance (Kern & Sohn, Germany). The extrapolation to 10 minutes calculated the MFR in g/10 min for each cut. For each material, one measurement was conducted. Within one measurement, 6 cuts were made and used for the calculation of average values and standard deviations.

### Density

The density measurements were conducted according to ISO 01183-1 (Plastics—Methods for determining the density of non-cellular plastics—Part 1: Immersion method, liquid pycnometer method and titration method) with a Sartorius CPA 225D lab balance (Sartorius, Germany).

Samples were cut from the sprue-sided shoulders of multi-purpose specimens (MPS). In the first step, the respective sample was weighed dry, measuring its mass in air (m_{S,A}). In the second step, the sample was immersed in deionized water with added detergent and put below a buoyancy cage which was connected to the scale, enabling the measurement of the sample buoyancy (m_{S.IL}) without the need of a sinker. A wire was used to free the sample of air bubbles and the temperature of the immersion liquid was recorded for the calculation of its density (p_{IL}). The sample density was calculated according to following formula with measurement apparatus correction variables A and B:

$${ρ}_{s} = \frac{{m}_{S . A} * {ρ}_{IL}}{A * ( {m}_{S . A} - {m}_{S . IL} )} + B$$

For each material, five samples, each cut from an individual MPS, were used for the calculation of average values and standard deviations.

### Differential Scanning Calorimetry (DSC)

DSC tests were carried out on a Perkin Elmer differential scanning calorimeter DSC 8500 (PerkinElmer, USA). Samples were cut from shoulders of injection molded multi-purpose specimens and encapsuled in perforated aluminum pans. The average sample weight was around 8 mg. The procedure consisted of a first heating, subsequent cooling, and a second heating phase, each in the temperature range of 0° C. to 200° C. with a constant heating/cooling rate of 10 K/min with nitrogen as purge gas and a flow rate of 20 ml/min. The DSC measurements were accomplished to determine the melting peak in the second heat-up phase which is characteristic for the semi-crystallinity achieved under controlled cooling in the DSC device. To determine the melting enthalpy, the area of the melting peak was integrated. Due to the normalization of the heat flux via the specimen mass the thermogram can be shown as normalized heat flux (W/g) over time (s) and the area of the peak (W/g*s) will calculate to W*s/g or J/g normalized melting enthalpy. For each material, five samples, each cut from an individual MPS, were used for the calculation of average values and standard deviations. Measurements were made according to ISO 11357-1 (Plastics—Differential scanning calorimetry (DSC)—Part 1: General principles) and ISO 11357-3 (Part 3: Determination of temperature and enthalpy of melting and crystallization). In short, the area of the melting peak in the second heating run was integrated.

### Oxidation Induction Temperature (T_{OX})

A differential thermal analysis (DTA) instrument of the type DSC 4000 (PerkinElmer, USA) was utilized to characterize the oxidation induction temperature (dynamic OIT) according to ISO 11357-6 (Plastics—Differential scanning calorimetry (DSC)—Part 6: Determination of oxidation induction time (isothermal OIT) and oxidation induction temperature (dynamic OIT)). Samples were cut from shoulders of injection molded MPS and encapsuled in perforated aluminum pans. The average sample weight was around 8 mg. A single heating step between 23° C. and 300° C. was performed with a heating rate of 10 K/min with synthetic air as purge gas and a flow rate of 20 ml/min. The point of intersect of the slope before oxidation and during oxidation gives the onset of oxidation or the oxidation induction temperature in ° C. For each material, five samples, each cut from an individual MPS, were used for the calculation of average values and standard deviations.

### Tensile Properties

The mechanical properties (Young's modulus, yield strength and strain at break) were examined with a universal testing machine Zwick AllroundLine Z020 (Zwick Roell, Germany) equipped with a multi-extensometer at 23° C. Test parameters and MPS were used according to ISO 527-1 (Plastics—Determination of tensile properties—Part 1: General principles) and ISO 527-2 (Part 2: Test conditions for molding and extrusion plastics) with a traverse speed of 1 mm/min for Young's modulus determination until a strain of 0.25% and after that 50 mm/min until failure. For each material five MPS were tested for the calculation of average values and standard deviations.

### Charpy Notched Impact Strength

Impact tests were conducted according to ISO 179-1 (Plastics—Determination of Charpy impact properties—Part 1: Non-instrumented impact test) on a Zwick/Roell HIT25P pendulum impact tester (Zwick Roell, Germany) with injection molded specimens (see information below). After pretests to determine the suitable pendulum size, appropriate pendulums were chosen for testing each respective material. Notches were produced with a Leica RM2265 microtome (Leica, Germany) and measured on an Olympus SZX16 stereomicroscope (Olympus, Japan). Test conditions were 23° C. with edgewise notched specimens with 0.25 mm notch-radius (1eA). For each material ten specimens were tested for the calculation of average values and standard deviations.

### Cracked Round Bar Method

For investigation of the fatigue crack growth (FCG) performance following ISO 18489:2015 (Polyethylene (PE) materials for piping systems—Determination of resistance to slow crack growth under cyclic loading—Cracked Round Bar test method), all materials were tested with an electro-dynamic testing machine of the type ElectroPuls E10000 (Instron, USA). To produce CRB specimens, plates were sheet molded and subsequently cut, lathed, and notched according to ISO 18489. Sinusoidal loading profiles with a frequency of 10 Hz, an R-ratio of 0.1 and individually adjusted initial stress intensity factor ranges (ΔK_{I}) were used to achieve testing times between 10 hours and 100 hours. ΔK_{I} values were corrected with the actual initial crack length which was measured via an Olympus SZX16 stereomicroscope (Olympus, Japan) after the test. The results are plotted in ΔK_{I} over cycles to failure. At least three measurements were made per material to generate curves which show the dependency of failure time over loading. The value of ΔK_{I} at 8E5 cycles is derived from a linear regression.

Different blends of recycled material were used. The blends are characterized by the following properties:
Blend A1: C2 content 8-9 wt %, C2 (CF) content 7-8 wt %, C2 (SF) content 29-30 wt %, intrinsic viscosity 1.6-1.7 dL/g; MFR₂ 15-16 g/10 min, Youngs modulus 1100-1200 MPa, Impact strength (charpy test 23° C.) 6-7 KJ/m²
Blend A2: C2 content 7-8 wt %, C2 (CF) content −4-5 wt %, C2 (SF) content 30-31 wt %, intrinsic viscosity 1.7-1.8 dL/g; MFR₂ 13-14 g/10 min, Youngs modulus 1300-1400 MPa, Impact strength (charpy test 23° C.) 6-7 KJ/m²
Blend A3: C2 content 32-33 wt %, C2 (CF) content 31-32 wt %, C2 (SF) content 34-35 wt %, intrinsic viscosity 1.8-1.9 dL/g; MFR₂ 9-10 g/10 min, Youngs modulus 1000-1100 MPa, Impact strength (charpy test 23° C.) 5-6 KJ/m²

The following additives were used: Antioxidants: AO1 (Irganox1010FF), AO2 (IRGAFOS 168FF).

In the following Table 1 several examples (comparative-CE; inventive-IE) are summarized.

Table 1 refers to a polyolefin composition comprising
a) (IE1, IE2, IE3) one heterophasic polypropylene copolymer (HECO-1, impact strength 20 kJ/m²), Blend A1 and additives (AO1, AO2);
b) (IE4, IE5, IE6) one heterophasic polypropylene copolymer (HECO-1, impact strength 20 kJ/m²), Blend A2 and additives (AO1, AO2);
c) (IE7) one heterophasic polypropylene copolymer (HECO-1, impact strength 20 kJ/m²), Blend A3 and additives (AO1, AO2);
d) (CE1, CE2, CE3) one heterophasic polypropylene copolymer (HECO-2, impact strength 55 kJ/m²), Blend A1 and additives (AO1, AO2);
e) (CE4) one heterophasic polypropylene copolymer (HECO-1, impact strength 33 kJ/m²),
f) (CE5) one heterophasic polypropylene copolymer (HECO-2, impact strength 55 kJ/m²),
g) (CE6) Blend A1 of recyclate material,
h) (CE7) Blend A2 of recyclate material,
i) (CE8) Blend A3 of recyclate material.

As can be seen in Table 1, when adding recyclate blends A1-A3 to HECO-1 the charpy notched impact strength value of the inventive polyolefin composition (IE1-7) decreases from the virgin HECO-1 (CE4), but to a lesser extent than compared to HECO-2. When adding 10% recyclate blend A1 to the HECO-1 the charpy notched impact strength is 65% of the virgin HECO-1. However, when adding 20% recyclate blend A1 to HECO-1 the charpy notched impact strength value is decreasing to 60% of HECO-1, and when adding 30% recyclate blend A1 to Heco-1 the charpy notched impact strength value is only about 52% of HECO-1. The fact that the charpy notched impact strength value of the inventive polyolefin composition with up to 30 wt % recyclate blend does only decrease by about 48% in comparison to the virgin polymer was surprising.

Furthermore, the ΔK_{I} value as a measure for fatigue growth rate of the inventive polyolefin compositions decreases only to a small extent by 8-15% depending on the amount of recyclate added.

In contrast, when adding recyclate blend A1 to HECO-2 (CE1-3) the charpy notched impact strength value decreases rapidly in comparison to the virgin polymer HECO-2 (CE5). Specifically, when adding 10% recyclate blend A1 to the HECO-2 the charpy notched impact strength is 91% of the virgin HECO-2: However, when adding 20% recyclate blend A1 to HECO-2 the charpy notched impact strength value is decreasing to 34% of HECO-2, and when adding 30% recyclate blend A1 to Heco-2 the charpy notched impact strength value is only about 23% of HECO-2.

TABLE 1

| | IE1 | IE2 | IE3 | IE4 | IE5 | IE6 | IE7 | CE1 |
|---|---|---|---|---|---|---|---|---|
| | 10 | 20 | 30 | 10 | 20 | 30 | 20 | 10 |
| | wt % | wt % | wt % | wt % | wt % | wt % | wt % | wt % |
| | Blend | Blend | Blend | Blend | Blend | Blend | Blend | Blend |
| | A1 | A1 | A1 | A2 | A2 | A2 | A3 | A1 |
| HECO-1 | 89.73 | 79.76 | 69.79 | 89.73 | 79.76 | 69.79 | 79.76 | |
| [wt %] | | | | | | | | |
| HECO-2 | | | | | | | | 89.73 |
| [wt %] | | | | | | | | |
| Blend | 9.97 | 19.94 | 29.91 | | | | | 9.97 |
| A1 | | | | | | | | |
| [wt %] | | | | | | | | |
| Blend | | | | 9.97 | 19.94 | 29.91 | | |
| A2 | | | | | | | | |
| [wt %] | | | | | | | | |
| Blend | | | | | | | 19.94 | |
| A3 | | | | | | | | |
| [wt %] | | | | | | | | |
| AO1 | 0.15 | 0.15 | 0.15 | 0.15 | 0.15 | 0.15 | 0.15 | 0.15 |
| [wt %] | | | | | | | | |
| AO2 | 0.15 | 0.15 | 0.15 | 0.15 | 0.15 | 0.15 | 0.15 | 0.15 |
| [wt %] | | | | | | | | |
| MFR | 0.34 | 0.44 | 0.76 | 0.33 | 0.47 | 0.72 | 0.39 | 0.39 |
| (230° | | | | | | | | |
| C./2.16 kg) | | | | | | | | |
| [g/10 min] | | | | | | | | |
| Charpy | 21.6 | 19.8 | 17.3 | 20.8 | 19.3 | 17.2 | 20.2 | 50.7 |
| notched | | | | | | | | |
| impact | | | | | | | | |
| strength | | | | | | | | |
| [kJ/m²] | | | | | | | | |
| Young's | 1720 | 1620 | 1570 | 1710 | 1620 | 1600 | 1550 | 1470 |
| Modulus | | | | | | | | |
| [MPa] | | | | | | | | |
| Yield | 34.6 | 34.0 | 33.5 | 34.4 | 33.9 | 33.2 | 33.0 | 30.5 |
| Strength | | | | | | | | |
| [MPa] | | | | | | | | |
| Strain- | 59.9 | 70.6 | 115.3 | 60.8 | 54.7 | 195.1 | 67.7 | 155 |
| at-break | | | | | | | | |
| [%] | | | | | | | | |
| ΔK_{I} | 1.074 | 1.026 | 0.964 | 1.09 | 1.022 | 0.992 | 0.987 | 0.9345 |
| [MPa · m^{0.5}] | | | | | | | | |
| at 8E5 | | | | | | | | |
| cycles | | | | | | | | |
| Density | 0.9130 | 0.9141 | 0.9146 | 0.9126 | 0.9133 | 0.9139 | 0.9172 | 0.9142 |
| [g/cm³] | | | | | | | | |
| Melting | 166.78 | 166.22 | 165.55 | 166.33 | 166.54 | 166.19 | 167.83 | 165.88 |
| peak | | | | | | | | |
| PP [° C.] | | | | | | | | |
| Melting | 103.57 | 102.96 | 101.63 | 105.31 | 98.66 | 103.95 | 76.38 | 90.88 |
| enthalpy | | | | | | | | |
| PP | | | | | | | | |
| [J/g] | | | | | | | | |
| Melting | 123.04 | 123.70 | 123.71 | 122.75 | 123.21 | 124.07 | 126.41 | 122.63 |
| peak | | | | | | | | |
| PE | | | | | | | | |
| [° C.] | | | | | | | | |
| Melting | 0.05 | 0.25 | 0.40 | 0.04 | 0.16 | 0.29 | 2.72 | 0.24 |
| enthalpy | | | | | | | | |
| PE | | | | | | | | |
| [J/g] | | | | | | | | |
| Oxidation | 271.4 | 269.2 | 269.3 | 273.9 | 271.7 | 267.5 | 271.8 | 273.5 |
| induction | | | | | | | | |
| temperature | | | | | | | | |
| [° | | | | | | | | |
| C.] | | | | | | | | |
| XCS | | | | | | | | |
| content | | | | | | | | |
| [wt %] | | | | | | | | |
| Crystex data | | | | | | | | |
| C2 | | | | | | | | |
| content | | | | | | | | |
| [wt %] | | | | | | | | |
| C2 | | | | | | | | |
| content | | | | | | | | |
| crystalline | | | | | | | | |
| fraction | | | | | | | | |
| [wt %] | | | | | | | | |
| C2 | | | | | | | | |
| content | | | | | | | | |
| soluble | | | | | | | | |
| fraction | | | | | | | | |
| [wt %] | | | | | | | | |
| intrinsic | | | | | | | | |
| viscosity | | | | | | | | |
| [dL/g] | | | | | | | | |
| intrinsic | | | | | | | | |
| viscosity | | | | | | | | |
| crystalline | | | | | | | | |
| fraction | | | | | | | | |
| [dL/g] | | | | | | | | |
| intrinsic | | | | | | | | |
| viscosity | | | | | | | | |
| soluble | | | | | | | | |
| fraction | | | | | | | | |
| [dL/g] | | | | | | | | |
| soluble | | | | | | | | |
| fraction | | | | | | | | |
| content | | | | | | | | |
| [wt %] | | | | | | | | |

| | CE2 | CE3 | | | | | |
|---|---|---|---|---|---|---|---|
| | 20 | 30 | | | | | |
| | wt % | wt % | | | CE6 | CE7 | CE8 |
| | Blend | Blend | CE4 | CE5 | Blend | Blend | Blend |
| | A1 | A1 | Heco-1 | Heco-2 | A1 | A2 | A3 |
| HECO-1 | | | | | | | |
| [wt %] | | | | | | | |
| HECO-2 | 79.76 | 69.79 | | | | | |
| [wt %] | | | | | | | |
| Blend | 19.94 | 29.91 | | | | | |
| A1 | | | | | | | |
| [wt %] | | | | | | | |
| Blend | | | | | | | |
| A2 | | | | | | | |
| [wt %] | | | | | | | |
| Blend | | | | | | | |
| A3 | | | | | | | |
| [wt %] | | | | | | | |
| AO1 | 0.15 | 0.15 | | | | | |
| [wt %] | | | | | | | |
| AO2 | 0.15 | 0.15 | | | | | |
| [wt %] | | | | | | | |
| MFR | 0.60 | 0.83 | 0.23 | 0.25 | 15.75 | 13.30 | 9.14 |
| (230° | | | | | | | |
| C./2.16 kg) | | | | | | | |
| [g/10 min] | | | | | | | |
| Charpy | 18.8 | 12.6 | 33.2 | 55.7 | 6.2 | 6.8 | 5.5 |
| notched | | | | | | | |
| impact | | | | | | | |
| strength | | | | | | | |
| [kJ/m²] | | | | | | | |
| Young's | 1430 | 1400 | 1850 | 1530 | 1170 | 1320 | 1010 |
| Modulus | | | | | | | |
| [MPa] | | | | | | | |
| Yield | 30.2 | 29.8 | 35.2 | 30.8 | 27.2 | 28.1 | 22.3 |
| Strength | | | | | | | |
| [MPa] | | | | | | | |
| Strain- | 153.7 | 222.9 | 44.2 | 54.7 | 46.5 | 38.9 | 13.7 |
| at-break | | | | | | | |
| [%] | | | | | | | |
| ΔK_{I} | 0.888 | 0.854 | 1.1499 | 0.972 | | | |
| [MPa · m^{0.5}] | | | | | | | |
| at 8E5 | | | | | | | |
| cycles | | | | | | | |
| Density | 0.9143 | 0.9145 | 0.9123 | 0.9109 | | | |
| [g/cm³] | | | | | | | |
| Melting | 165.16 | 165.48 | 166.82 | 167.05 | | | |
| peak | | | | | | | |
| PP [° C.] | | | | | | | |
| Melting | 88.86 | 89.95 | 104.69 | 94.74 | | | |
| enthalpy | | | | | | | |
| PP | | | | | | | |
| [J/g] | | | | | | | |
| Melting | 123.54 | 124.09 | 117.27 | 117.54 | | | |
| peak | | | | | | | |
| PE | | | | | | | |
| [° C.] | | | | | | | |
| Melting | 0.54 | 0.88 | 0.03 | 0.15 | | | |
| enthalpy | | | | | | | |
| PE | | | | | | | |
| [J/g] | | | | | | | |
| Oxidation | 267.1 | 267.0 | 260.9 | 266.1 | 209.5 | 211.6 | 210.8 |
| induction | | | | | | | |
| temperature | | | | | | | |
| [° | | | | | | | |
| C.] | | | | | | | |
| XCS | | | 6.16 | 10.78 | | | |
| content | | | | | | | |
| [wt %] | | | | | | | |
| Crystex data | | | | | | | |
| C2 | | | 1.35 | 4.79 | 8.86 | 7.09 | 32.2 |
| content | | | | | | | |
| [wt %] | | | | | | | |
| C2 | | | 0.3 | 2.1 | 7.16 | 4.49 | 31.96 |
| content | | | | | | | |
| crystalline | | | | | | | |
| fraction | | | | | | | |
| [wt %] | | | | | | | |
| C2 | | | 18.99 | 35.73 | 29.3 | 30.16 | 34.72 |
| content | | | | | | | |
| soluble | | | | | | | |
| fraction | | | | | | | |
| [wt %] | | | | | | | |
| intrinsic | | | 4.05 | 4.02 | 1.68 | 1.74 | 1.85 |
| viscosity | | | | | | | |
| [dL/g] | | | | | | | |
| intrinsic | | | 4.02 | 4.09 | 1.7 | 1.73 | 1.87 |
| viscosity | | | | | | | |
| crystalline | | | | | | | |
| fraction | | | | | | | |
| [dL/g] | | | | | | | |
| intrinsic | | | 3.54 | 4.47 | 1.44 | 1.75 | 1.36 |
| viscosity | | | | | | | |
| soluble | | | | | | | |
| fraction | | | | | | | |
| [dL/g] | | | | | | | |
| soluble | | | 5.63 | 10.04 | 9.3 | 10.54 | 8.8 |
| fraction | | | | | | | |
| content | | | | | | | |
| [wt %] | | | | | | | |

### Resistance to FCG

As can be seen from Table 1 the resistance to fatigue crack growth of polyolefin compositions according to the disclosure comprising the virgin HECO-1 and the recyclate blends varies with recyclate load; the lower the recyclate load the higher the resistance to fatigue crack growth.

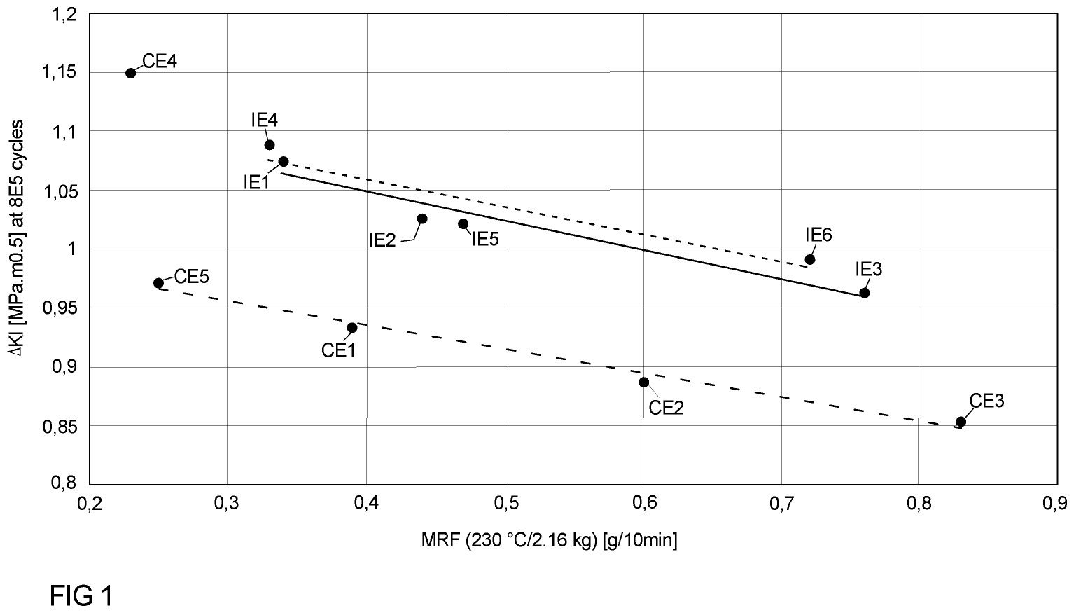

The diagram of FIG. 1 illustrates the resistance to fatigue crack growth ΔK_{I}[MPa*m^{0.5}] at 8E5 cycles over melt flow rate [g/10 min] of the different compositions.

ΔK_{I} at 8E5 cycles is used to evaluate resistance to fatigue crack growth of the compounds in comparison to virgin polymer references. All inventive compounds (HECO-1/recyclate blend) have higher ΔK_{I} at 8E5 cycles, suggesting better resistance to fatigue crack growth, than HECO-2 based compounds. Most of them even show higher ΔK_{I} at 8E5 cycles than HECO-2 that has similar MFR to HECO-1.

Furthermore, the diagram of FIG. 1 indicates that MFR has great influence on resistance to fatigue crack growth: the lower the MFR the better the resistance to fatigue crack growth.

1. A polyolefin composition comprising
60-95 wt % (based on the overall weight of the polyolefin composition) of at least one heterophasic propylene copolymer (HECO) with a total ethylene (C2) content (as determined according to CRYSTEX QC analysis) of 0.5 to 4.5 wt.-%, and a xylene cold soluble fraction (determined at 25° C. according to ISO 16152) of 2-9 wt % and a melt flow rate MFR₂ (ISO 1133, 2.16 kg, 230° C., measured according to ISO 1133) of 0.1 to 1 g/10 min;
5-40 wt % (based on the overall weight of the polyolefin composition) of a mixed-plastics polypropylene blend of recycled material having an ethylene (C2) content determined according to CRYSTEX QC analysis of 5 to 35 wt %, and
optionally further additives, wherein the sum of all ingredients always adds up to 100 wt %,
wherein the polyolefin composition has
a melt flow rate MFR₂ (230° C., 2.16 kg, measured according to ISO 1133) of at least 0.3 g/10 min; and
an impact strength (ISO179-1, Charpy 1eA+23° C.) of at least 15 kJ/m².

2. The polyolefin composition according to claim 1, comprising,
70-90 wt % (based on the overall weight of the polyolefin composition) of at least one heterophasic propylene copolymer (HECO) with a total ethylene (C2) content (as determined according to CRYSTEX QC analysis) of 0.5 to 4.5 wt.-%, and a xylene cold soluble fraction (determined at 25° C. according to ISO 16152) of 2 to 7 wt %;
10-30 wt % (based on the overall weight of the polyolefin composition) of a mixed-plastics polypropylene blend of recycled material having an ethylene (C2) content determined according to CRYSTEX QC analysis of 5 to 35 wt %, and
optionally further additives, wherein the sum of all ingredients always adds up to 100 wt %.

3. The polyolefin composition according to claim 1, wherein the polyolefin composition has a melt flow rate MFR₂ (2.16 kg, 230° C., measured according to ISO 1133) of 0.3 to 1 g/10 min.

4. The polyolefin composition according to claim 1, wherein the polyolefin composition has an impact strength (ISO179-1, Charpy 1eA+23° C.) of at least 17 kJ/m².

5. The polyolefin composition according to claim 1, wherein the polyolefin composition has a ΔK_{I} (derived from Cracked round bar testing according to ISO 18489:2015) of more than 0.8 MPa*m^{0.5} at 8E5 cycles.

6. The polyolefin composition according to claim 1, wherein the at least one heterophasic propylene copolymer (HECO) comprises a propylene homopolymer and a propylene-ethylene rubber as elastomeric propylene copolymer as matrix.

7. The polyolefin composition according to claim 1, wherein the at least one heterophasic propylene copolymer (HECO) has a melt flow rate MFR₂ (ISO 1133, 2.16 kg, 230° C., measured according to ISO 1133) of 0.1 to 0.9 g/10 min.

8. The polyolefin composition according to claim 1, wherein the least one heterophasic propylene copolymer (HECO) has an impact strength (ISO179-1, Charpy 1eA+23° C.) of at least 17 kJ/m².

9. The polyolefin composition according to claim 1, wherein the mixed-plastics polypropylene blend of recycled material has an ethylene (C2) content determined according to CRYSTEX QC analysis of 5 to 20 wt %, and a C2 (CF) content of the crystalline fraction (as determined according to CRYSTEX QC analysis) of 1-35 wt %.

10. The polyolefin composition according to claim 1, wherein the mixed-plastics polypropylene blend of recycled material has a melt flow rate (ISO1133, 2.16 kg; 230° C.) of 5 to 30 g/10 min.

11. The polyolefin composition according to claim 1, wherein the mixed-plastics polypropylene blend of recycled material has an impact strength (ISO179-1, Charpy 1eA+23° C.) of at least 4 kJ/m².

12. The polyolefin composition according to claim 1, wherein the mixed-plastics polypropylene blend of recycled material comprises one or more of the following substances: polystyrene, polyamide-6 as determined by FTIR, and/or limonene as determined by using solid phase microextraction (HS-SPME-GC-MS).

13. (canceled)

14. A process for producing the polyolefin composition according to claim 1, wherein the process comprises the steps of
providing a mixture of 60-95 wt % (based on the total weight of the polyolefin composition) of the at least one heterophasic propylene copolymer (HECO) with a total ethylene (C2) content (as determined according to CRYSTEX QC analysis) of 0.5 to 4.5 wt. %, and a xylene cold soluble fraction (determined at 25° C. according to ISO 16152) of 2-9 wt % and a melt flow rate MFR₂ (ISO 1133, 2.16 kg, 230° C., measured according to ISO 1133) of 0.1 to 1 g/10 mm, and 5-40 wt % (based on the overall weight of the polyolefin composition) of a mixed-plastics polypropylene blend of recycled material having an ethylene (C2) content determined according to CRYSTEX QC analysis of 5 to 35 wt %, and optionally further additives
melting the mixture in an extruder, and
optionally pelletizing the obtained polyolefin composition.

15. An article comprising the polyolefin composition according to claim 1.

16. The article of claim 15, wherein the article is a pipe.

17. The polyolefin composition according to claim 1, wherein the polyolefin composition has a melt flow rate MFR₂ (2.16 kg, 230° C., measured according to ISO 1133) of 0.4 to 0.8 g/10 min.

18. The polyolefin composition according to claim 1, wherein the polyolefin composition has an impact strength (ISO179-1, Charpy 1eA+23° C.) is 15 to 25 kJ/m².

19. The polyolefin composition according to claim 1, wherein the polyolefin composition has a ΔK_{I} (derived from Cracked round bar testing according to ISO 18489:2015) of more than 0.9 MPa*m^{0.5} at 8E5 cycles.
